(19) United States
(12) Patent Application Publication
(10) Pub. No.: US 2015/0221122 A1
(43) Pub. Date: Aug. 6, 2015

(54) METHOD AND APPARATUS FOR RENDERING GRAPHICS DATA

(71) Applicant: SAMSUNG ELECTRONICS CO., LTD., Suwon-si (KR)

(72) Inventors: Min-young SON, Hwaseong-si (KR); Kwon-taek KWON, Seoul (KR); Sang-oak WOO, Anyang-si (KR)

(73) Assignee: SAMSUNG ELECTRONICS CO., LTD., Suwon-si (KR)

(21) Appl. No.: 14/329,210

(22) Filed: Jul. 11, 2014

(30) Foreign Application Priority Data
Feb. 6, 2014 (KR) 10-2014-0013825

(51) Int. Cl. G06T 15/00; G06T 15/40; G06T 15/30; G06T 19/20; G06T 15/10; G06T 15/20

(52) U.S. Cl. CPC G06T 15/005; G06T 15/10; G06T 15/205; G06T 15/30; G06T 19/20; G06T 15/405; G06T 2215/16; G06T 2219/2012

(57) ABSTRACT

Methods and apparatuses of rendering graphics data are disclosed to reduce the amount of computation to be performed in rendering the graphics data. The method of rendering graphics data includes extracting, at an extractor for rendering graphics data, an object existing at a first frame and a second frame on the basis of attribute information of the object in the first frame and attribute information the object in the second frame, comparing first viewpoint information of the object in the first frame with second viewpoint information of the object in the second frame, and acquiring geometric data of the object in a second viewpoint on the basis of geometric data of the object in a first viewpoint and the viewpoint comparison information.

### RELATED APPLICATION

This application claims the benefit under 35 USC 119(a) of Korean Patent Application No. 10-2014-0013825, filed on Feb. 6, 2014, in the Korean Intellectual Property Office, the entire disclosure of which is incorporated herein by reference for all purposes.

### BACKGROUND

1. Field

The following description relates to methods and apparatuses for rendering graphics data.

2. Description of Related Art

Devices for displaying graphics data on a screen have grown. For example, devices that use a user interface (UI) application in a mobile device and applications for simulation have increased.

An element affecting the display of graphics data on a screen is rendering speed. According to the existing technology of rendering graphics data, rendering computation for each frame is independently performed. When graphics data of a plurality of frames is rendered, all graphics data included in the plurality of frames are rendered. Due to a large amount of computation needed for rendering the graphics data, a large memory space is occupied and it takes a long time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of rendering graphics data, the method including extracting, at an extractor for rendering graphics data, an object existing at a first frame and a second frame on the basis of attribute information of the object in the first frame and attribute information the object in the second frame, comparing first viewpoint information of the object in the first frame with second viewpoint information of the object in the second frame, and acquiring geometric data of the object in a second viewpoint on the basis of geometric data of the object in a first viewpoint and the viewpoint comparison information.

The method may include acquiring geometric data of a fixed object in a current frame on the basis of geometric data of the fixed object in a previous frame and a viewpoint comparison information between the previous frame and the current frame.

The attribute information of the object may include any one or any combination of location information, color information, index information, and texture information of vertices forming the object.

The extracting of the object may include comparing the attribute information of the object included in the first frame with the attribute information of the object included in the second frame, and extracting, as the object, an object having the same attribute information in the first frame and the second frame.

The comparing may include acquiring a projection matrix of difference between the first viewpoint and the second viewpoint.

The acquiring of the geometric data of the object in the second viewpoint may include applying the projection matrix to the geometric data of the object in the first viewpoint.

The method may include acquiring rendering information of the object included in the first frame and the second frame, and extracting the attribute information and viewpoint information of the object included in the first frame and the second frame based on the acquired rendering information.

In another general aspect, there is provided an apparatus for rendering graphics data including an extractor configured to extract an object existing at a first frame and a second frame on the basis of attribute information of the object in the first frame and attribute information of the object included in the second frame, a comparator configured to compare first viewpoint information of the object in the first frame with second viewpoint information of the object in the second frame, and an acquirer configured to acquire geometric data of the object in a second viewpoint on the basis of geometric data of the object in a first viewpoint and the viewpoint comparison information.

The acquirer may be configured to acquire geometric data of a fixed object in a current frame on the basis of geometric data of the fixed object existing in a previous frame and a viewpoint comparison information between the previous frame and the current frame.

The attribute information of the object may include location information, color information, index information, and texture information of vertices forming the object.

The extractor may be configured to compare the attribute information of the object included in the first frame with the attribute information of the object included in the second frame and to extract, as the object, an object having the same attribute information in the first frame and the second frame.

The comparator may be configured to acquire a projection matrix of difference between the first viewpoint and the second viewpoint.

The acquirer may be configured to apply the projection matrix to the geometric data of the object in the first viewpoint.

The extractor may be configured to acquire rendering information of the object included in the first frame and the second frame and to extract the attribute information and viewpoint information of the object included in the first frame and the second frame based on the acquired rendering information.

In another general aspect, there is provided a method of rendering graphics data including extracting, at an extractor for rendering graphics data, an object existing at a same location in a first frame and a second frame on the basis of attribute information of the object in the first frame and attribute information the object in the second frame, comparing first viewpoint information of the object in the first frame with second viewpoint information of the object in the second frame, acquiring a projection matrix of difference between the first viewpoint and the second viewpoint, obtaining geometric data of the object in a second viewpoint based on applying the projection matrix to a geometric data of the object in the first viewpoint.

The attribute information of the object may include any one or any combination of location information, color information, index information, and texture information of vertices forming the object.

The extracting of the object may include extracting the object having the same attribute information in the first frame and the second frame.

Other features and aspects will be apparent from the following detailed description, the drawings, and the claims.

### BRIEF DESCRIPTION OF THE DRAWINGS

FIG. 1 is a diagram illustrating an example of a method of processing graphics data.

FIG. 2 is a diagram illustrating an example of a method of rendering graphics data.

FIG. 3 is a diagram illustrating an example of a method of extracting a fixed object by an apparatus for rendering graphics data.

FIG. 4 is a diagram illustrating an example of information included in draw calls, acquired by an apparatus for rendering graphics data.

FIG. 5 is a diagram illustrating an example of a method of acquiring a viewpoint information difference between different frames, by an apparatus for rendering graphics data.

FIG. 6 is a diagram illustrating an example of a method of acquiring geometric data of a fixed object existing in a second frame on the basis of geometric data of a fixed object existing in a first frame and a projection matrix, by an apparatus for rendering graphics data.

FIG. 7 is a diagram illustrating an example of a method of acquiring geometric data of a fixed object existing in a second frame, by an apparatus for rendering graphics data.

FIG. 8 is a diagram illustrating an example of an apparatus for rendering graphics data.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses, and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

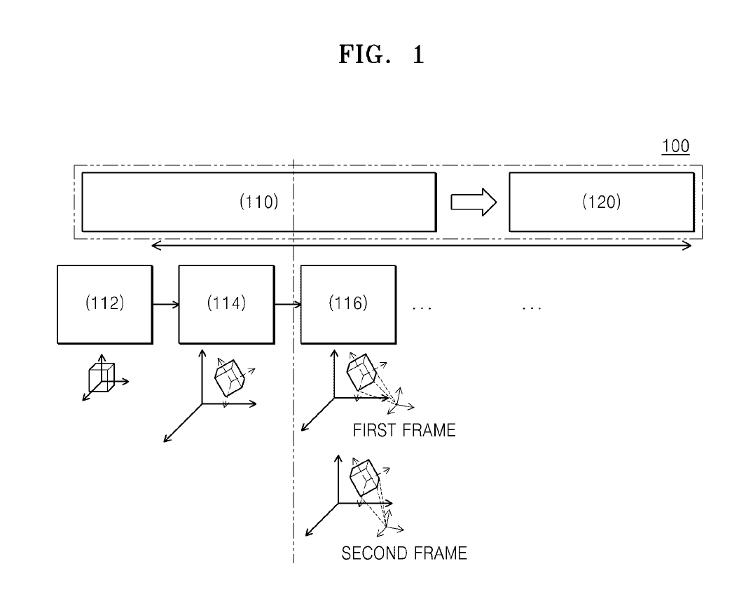

FIG. 1 is a diagram illustrating an example of describing a method of processing graphics data. Referring to FIG. 1, a pipeline 100 for rendering graphics data may include a geometry computation unit 110 and a fragment computation unit 120. The geometry computation unit 110 may perform a phase change of spatial vertices. The geometry computation unit 110 may project coordinates of the vertices onto a screen. The fragment computation unit 120 may generate pixels inside a polygon (e.g., a triangle, a tetragon) that is formed by the vertices. The fragment computation unit 120 may generate the pixels on the basis of the coordinates of the vertices projected onto the screen. In addition, the fragment computation unit 120 may calculate colors of the generated pixels.

The geometry computation unit 110 may include components, such as, for example, a local coordinate system transform unit 112, a world coordinate system transform unit 114, and a viewpoint coordinate system transform unit 116. While components related to the present example are illustrated in the geometry computation unit 110 of FIG. 1, it is understood that those skilled in the art may include other general components.

The processes performed by the geometry computation unit 110 may be classified on whether or not the processes are dependent on a camera viewpoint. The processes that are independent from the camera viewpoint may include a process performed by the local coordinate system transform unit 112 and a process performed by the world coordinate system transform unit 114.

The local coordinate system transform unit 112 may define triangular coordinates of an object. The coordinates of the object, which are defined by the local coordinate system transform unit 112, are coordinates obtained by considering only the object itself without considering a relationship of the object with another object and.

The world coordinate system transform unit 114 may transform the triangular coordinates of the object, which are defined by the local coordinate system transform unit 112, to a world coordinate system in consideration of a relationship with another object. The world coordinate system transform unit 114 may transform an object of a local coordinate system to the world coordinate system through operations, such as, for example, movement, rotation, and size deformation.

The processes that are independent from the camera viewpoint may include a process performed by the viewpoint coordinate system transform unit 116. The viewpoint coordinate system transform unit 116 may match the origin of a viewpoint coordinate system with the origin of the world coordinate system and set a viewing viewpoint as a negative z-axis direction, the upper direction as a y-axis direction, and the right direction as an x-axis direction. The viewpoint coordinate system transform unit 116 may transform coordinates of all objects in the world coordinate system to change the viewpoint with respect to the world.

When a motionless object exists between different frames, attribute information of the object generated by the viewpoint coordinate system transform unit 116 may be the same between the different frames. An apparatus for rendering graphics data may extract a fixed object, which does not move between different frames, and use location information of the fixed object in a previous frame as location information of the fixed object in a current frame during a series of rendering processes.

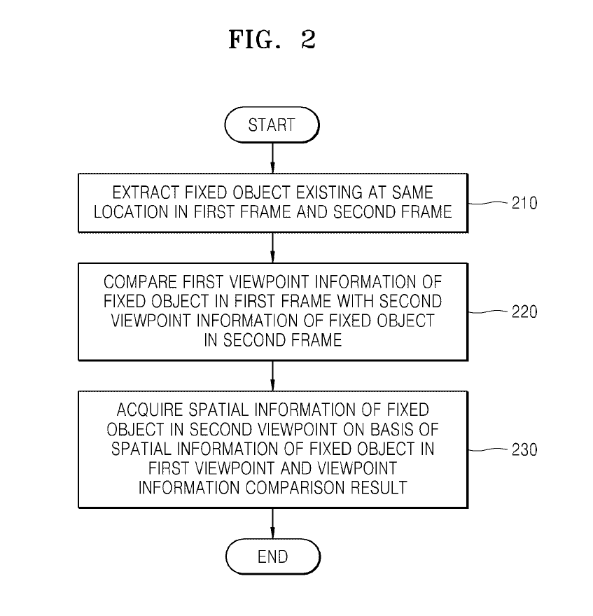

FIG. 2 is a diagram illustrating an example of a method of rendering graphics data. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. The above description of FIG. 1 is also applicable to FIG. 2, and is incorporated herein by reference. Thus, the above description may not be repeated here.

In 210, an apparatus for rendering graphics data extracts a fixed object existing at the same location in a first frame and a second frame on the basis of attribute information of at least one object included in the first frame and attribute information of at least one object included in the second frame. The attribute information of an object may include location information, color information, index information, and texture information of vertices forming the object.

The apparatus for rendering graphics data may compare the attribute information of the at least one object included in the first frame with the attribute information of the at least one object included in the second frame. A motionless fixed object may have the same attribute information in each frame. Therefore, the apparatus for rendering graphics data may extract, as a fixed object, an object having the same attribute information in each frame.

In 220, the apparatus for rendering graphics data compares first viewpoint information of the fixed object in the first frame with second viewpoint information of the fixed object in the second frame. The viewpoint information may include information about a direction of viewing an object in a certain frame. For example, the first viewpoint information may include information about a direction of viewing the fixed object in the first frame, and the second viewpoint information may include information about a direction of viewing the fixed object in the second frame.

In 230, the apparatus for rendering graphics data acquires geometric data of the fixed object in a second viewpoint on the basis of geometric data of the fixed object in a first viewpoint and a result of the viewpoint information comparison of 220. The geometric data of the fixed object in the first viewpoint may include location information and depth information of the fixed object in the first viewpoint. The location information and depth information are non-exhaustive examples of geometric data, but geometric data is not limited thereto. For example, the geometric data includes information about all variables by which a location of the fixed object is calculated and indicates data that is not influenced by a change in viewpoint.

When objects are rendered in a viewpoint coordinate system, if viewpoint information for rendering an object for each frame varies, rendering information of a fixed object for each frame may also vary. For example, color information and texture information in the rendering information may vary due to the influence of a light source when a viewpoint varies. However, geometric data in the rendering information is only influenced by a change in viewpoint and is not influenced by external causes, such as a light source.

The apparatus for rendering graphics data may acquire geometric data of fixed objects in frames having different viewpoint information on the basis of a difference in viewpoint information between the frames. The apparatus for rendering graphics data may acquire the geometric data of the fixed object in the second viewpoint using the geometric data of the fixed object in the first viewpoint and a difference in viewpoint information between the first frame and the second frame.

For example, when viewpoint information of a frame is given as matrix data, the apparatus for rendering graphics data may obtain a difference between matrix data in the first viewpoint and matrix data in the second viewpoint. The apparatus for rendering graphics data may acquire the geometric data of the fixed object in the second viewpoint by applying the difference of the matrix data to the geometric data in the first viewpoint.

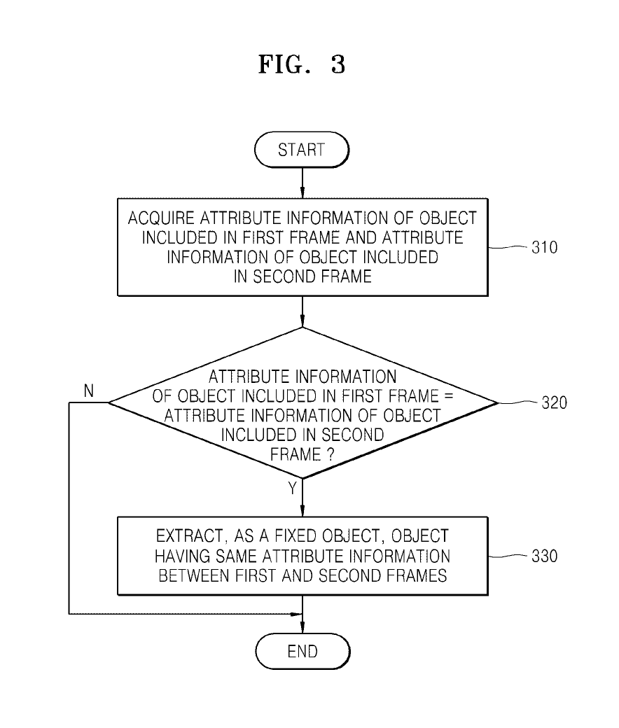

FIG. 3 is a diagram illustrating an example of a method of extracting a fixed object, by an apparatus for rendering graphics data. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. The above descriptions of FIGS. 1-2, are also applicable to FIG. 3, and are incorporated herein by reference. Thus, the above description may not be repeated here.

In 310, the apparatus for rendering graphics data acquires attribute information of at least one object included in a first frame and attribute information of at least one object included in a second frame.

The apparatus for rendering graphics data may acquire a draw call created by a graphic application. The graphic application may be an application, such as, for example, an application using three-dimensional (3D) graphics, an application capable of performing video game, an application capable of performing video conference, an application capable of displaying graphics. The apparatus for rendering graphics data may acquire attribute information of an object included in a frame based on at least one acquired draw call.

In 320, the apparatus for rendering graphics data compares the attribute information of the at least one object included in the first frame with the attribute information of the at least one object included in the second frame. The attribute information of an object, which is extracted from a draw call by the apparatus for rendering graphics data may include location information and index information of vertices forming the object.

The apparatus for rendering graphics data may compare location information and index information of vertices forming an object included in the first frame with location information and index information of vertices forming an object included in the second frame.

In 330, the apparatus for rendering graphics data extracts an object as a fixed object on the basis of the comparison. When location information and index information of an object included in each frame are the same, the apparatus for rendering graphics data may extract the object as a fixed object.

The location information and index information of vertices forming an object are only non-exhaustive examples of attribute information of the object, and the attribute information is not limited thereto. For example, the attribute information of the object may include color information, texture information, and the like.

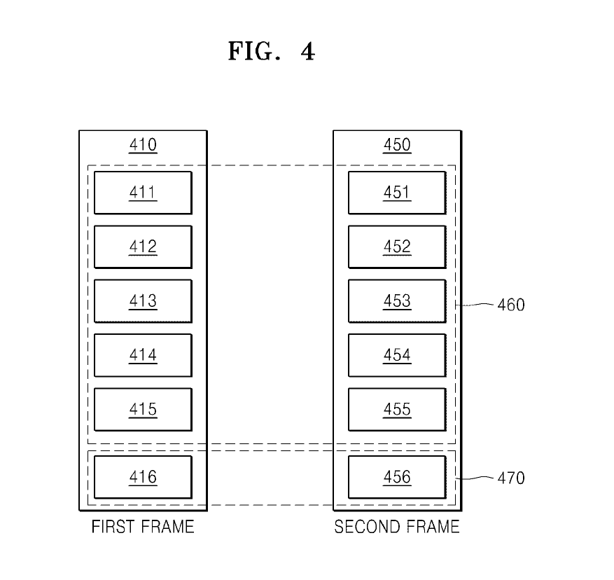

FIG. 4 is a diagram illustrating an example of information included in draw calls 410 and 450 of objects, which are acquired by an apparatus for rendering graphics data.

The apparatus for rendering graphics data may acquire the draw calls 410 and 450 created by a graphic application as rendering information of objects included in first and second frames, respectively. The rendering information, i.e., the draw calls 410 and 450, may include attribute information of the objects and viewpoint information of the frames.

The draw call 410 of the first frame may include attribute information 411, 412, 413, 414, and 415 of the object included in the first frame and viewpoint information 416 of the first frame. The draw call 410 of the first frame may include, as the attribute information of the object, vertex data 411 including locations, normal vectors, colors, and the like of vertices forming the object, index information 412 of the vertices forming the object, screen coordinate information 413 obtained by transforming 3D coordinates of the vertices forming the object into 2D coordinates, texture information 414 of the object, and state information 415 of the object.

The draw call 450 of the second frame may include attribute information 451, 452, 453, 454, and 455 of the object included in the second frame and viewpoint information 456 of the second frame. The draw call 450 of the second frame may include, as the attribute information of the object, vertex data 451 including locations, normal vectors, colors, and the like of vertices forming the object, index information 452 of the vertices forming the object, screen coordinate information 453 obtained by transforming 3D coordinates of the vertices forming the object into 2D coordinates, texture information 454 of the object, and state information 455 of the object.

The apparatus for rendering graphics data may detect a fixed object by comparing attribute information 460 included in the draw calls 410 and 450 of the first and second frames. If the attribute information 460, which is included in the draw calls 410 and 450 of the first and second frames, is the same, the objects may be determined as fixed objects existing at the same location in the first frame and the second frame.

The apparatus for rendering graphics data may compare viewpoint information 470 included in the draw calls 410 and 450 of the first and second frames. The apparatus for rendering graphics data may acquire geometric data of a fixed object in a viewpoint coordinate system that is transformed on the basis of second viewpoint information, on the basis of a difference in the viewpoint information 470 included in the draw calls 410 and 450 of the first and second frames, respectively.

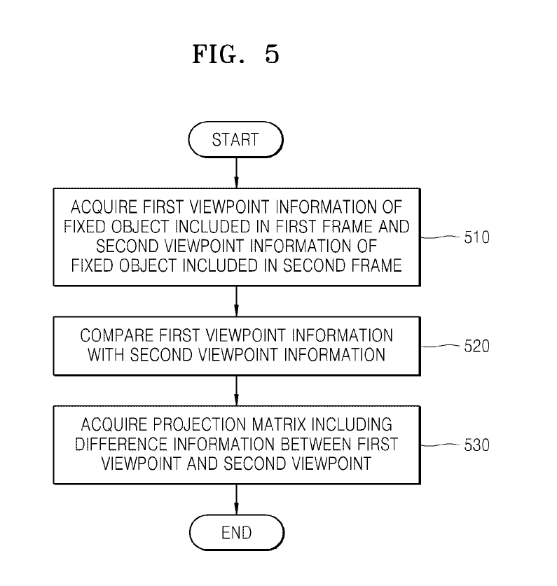

FIG. 5 is a diagram illustrating an example of a method of acquiring a viewpoint information difference between different frames, by an apparatus for rendering graphics data. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. The above descriptions of FIGS. 1-4, are also applicable to FIG. 5, and are incorporated herein by reference. Thus, the above description may not be repeated here.

In 510, the apparatus for rendering graphics data acquires first viewpoint information of a fixed object included in a first frame and second viewpoint information of a fixed object included in a second frame.

The apparatus for rendering graphics data may extract a fixed object between the first frame and the second frame by comparing attribute information of at least one object included in the first frame with attribute information of at least one object included in the second frame. A method of extracting the fixed object between the first frame and the second frame may correspond to the method described with reference to FIG. 3, and that description is incorporated herein by reference.

The apparatus for rendering graphics data may extract viewpoint information of each frame from the rendering information acquired of a fixed object in each frame. The rendering information of a fixed object in each frame may be included in a draw call for each frame. The rendering information included in a draw call is described with reference to FIG. 4, and that description is incorporated herein by reference.

In 520, the apparatus for rendering graphics data compares the first viewpoint information of the first frame with the second viewpoint information of the second frame. According to a non-exhaustive example, the viewpoint information of each frame may be given as matrix information. For example, the first viewpoint information of the first frame may include a first viewpoint transform matrix, and the second viewpoint information of the second frame may include a second viewpoint transform matrix. However, the viewpoint information given as matrix information is only a non-exhaustive example, and the viewpoint information of a frame is not limited thereto. For example, the viewpoint information of a frame may be given as vector information.

In 530, the apparatus for rendering graphics data acquires a projection matrix including difference information between a first viewpoint and a second viewpoint on the basis of the comparison.

The apparatus for rendering graphics data may acquire difference information between the first viewpoint transform matrix and the second viewpoint transform matrix by comparing the first viewpoint transform matrix with the second viewpoint transform matrix. For example, the projection matrix may be acquired by computing a difference between the first viewpoint transform matrix and the second viewpoint transform matrix.

The apparatus for rendering graphics data may acquire geometric data of the fixed object existing in the second frame by applying the projection matrix to geometric data of the fixed object existing in the first frame. The geometric data may include location information and depth information of a fixed object in the viewpoint coordinate system.

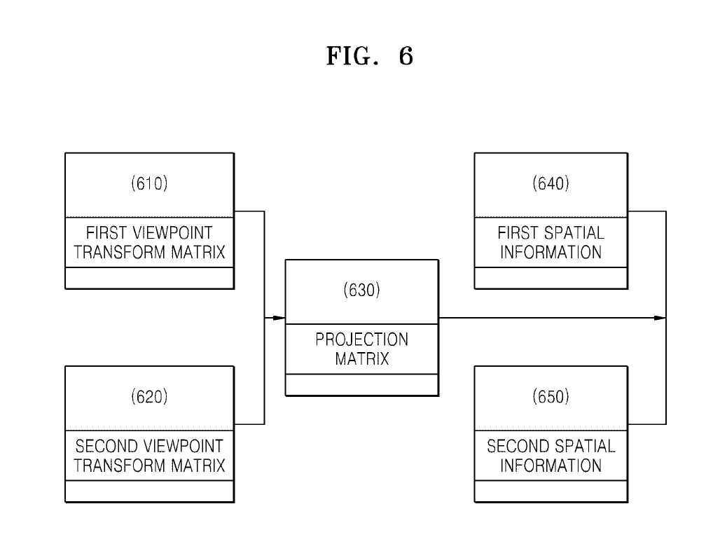

A method by which an apparatus for rendering graphics data acquires geometric data of a fixed object existing in a second frame will now be described in more detail with reference to FIG. 6.

FIG. 6 is a diagram illustrating an example of a method of acquiring geometric data of a fixed object existing in a second frame on the basis of geometric data of a fixed object existing in a first frame and a projection matrix, by an apparatus for rendering graphics data.

Referring to FIG. 6, the apparatus for rendering graphics data may acquire a projection matrix 630 by computing a difference value between a first viewpoint transform matrix 610 and a second viewpoint transform matrix 620.

The apparatus for rendering graphics data may acquire second geometric data 650 of the fixed object existing in the second frame by applying the projection matrix 630 to first geometric data 640 of the fixed object existing in the first frame.

The first frame may be a previous frame, and the second frame may be a current frame. The apparatus for rendering graphics data may extract a fixed object existing in the previous frame and in the current frame from among a plurality of frames. The apparatus for rendering graphics data may acquire geometric data of the extracted fixed object in the current frame by applying a projection matrix, which is a viewpoint information difference between the previous frame and the current frame, to geometric data of the extracted fixed object in the previous frame. For example, the apparatus for rendering graphics data may acquire the geometric data of the current frame by multiplying the geometric data of the previous frame by the projection matrix.

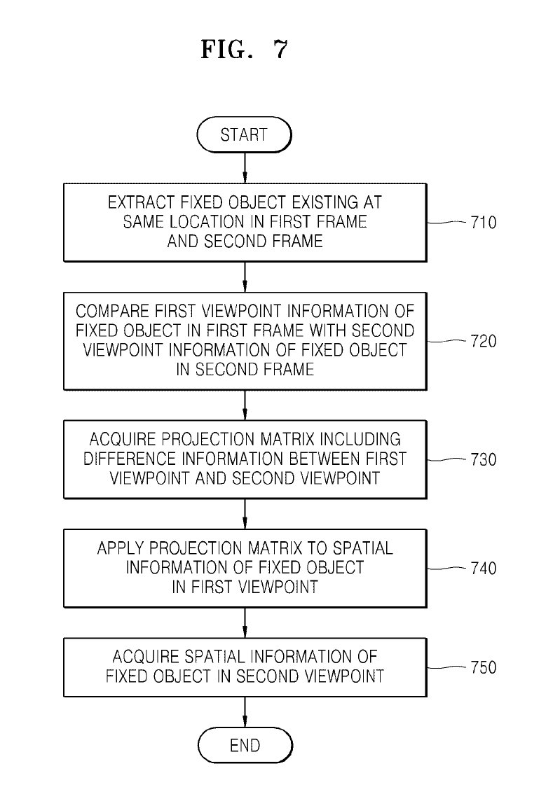

FIG. 7 is a diagram illustrating an example of a method of acquiring geometric data of a fixed object existing in a second frame, by an apparatus for rendering graphics data. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of FIGS. 1-6, are also applicable to FIG. 7, and are incorporated herein by reference. Thus, the above description may not be repeated here.

In 710, the apparatus for rendering graphics data extracts a fixed object existing at the same location in a first frame and a second frame. The apparatus for rendering graphics data may compare attribute information of at least one object included in the first frame with attribute information of at least one object included in the second frame. The apparatus for rendering graphics data may extract an object having the same attribute information in each frame as a fixed object based on the comparison.

In 720, the apparatus for rendering graphics data compares first viewpoint information of the fixed object in the first frame with second viewpoint information of the fixed object in the second frame.

When there is no difference between the first viewpoint information and the second viewpoint information, the apparatus for rendering graphics data may end a series of processes for acquiring geometric data of the fixed object in the second frame and use geometric data of the fixed object in the first frame as the geometric data of the fixed object in the second frame.

When there is a difference between the first viewpoint information and the second viewpoint information, the apparatus for rendering graphics data may acquire difference information between a first viewpoint and a second viewpoint.

In 730, the apparatus for rendering graphics data acquires a projection matrix including the difference information between the first viewpoint and the second viewpoint.

According to a non-exhaustive example, each of first viewpoint transform information and second viewpoint transform information may exist as matrix information. For example, the first viewpoint transform information may exist as a first viewpoint transform matrix, and the second viewpoint transform information may exist as a second viewpoint transform matrix. When viewpoint transform information exists as a matrix, the apparatus for rendering graphics data may acquire the projection matrix by obtaining a difference between the first viewpoint transform matrix and the second viewpoint transform matrix.

In 740, the apparatus for rendering graphics data applies the projection matrix to the geometric data of the fixed object in the first viewpoint.

The apparatus for rendering graphics data may apply the projection matrix to the geometric data of the fixed object in the first frame. The geometric data of the fixed object in the first frame may exist as a matrix in a viewpoint transform system based on the first viewpoint.

For example, the apparatus for rendering graphics data may multiply the projection matrix by the geometric data of the fixed object in the first frame existing as a matrix in the viewpoint transform system.

In 750, the apparatus for rendering graphics data acquires the geometric data of the fixed object in the second viewpoint. The apparatus for rendering graphics data may acquire, as the geometric data of the fixed object in the second viewpoint, a result of applying the projection matrix to the geometric data of the fixed object in the first frame.

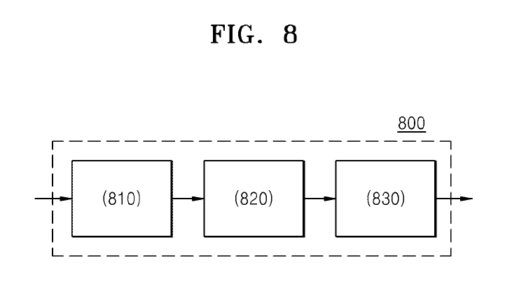

FIG. 8 is a diagram of an apparatus 800 for rendering graphics data. While components related to the present example are illustrated in the apparatus 800 shown of FIG. 8, it is understood that those skilled in the art may include other general components. Referring to FIG. 8, the apparatus 800 may include an extraction unit 810, a comparison unit 820, and an acquisition unit 830.

The extraction unit 810 may extract a fixed object existing at the same location of a first frame and a second frame based on attribute information of at least one object included in the first frame and the attribute information of at least one object included in the second frame.

The extraction unit 810 may compare the attribute information of the at least one object included in the first frame with the attribute information of the at least one object included in the second frame. In addition, the extraction unit 810 may extract, as the fixed object, an object having the same attribute information in the first frame and the second frame as a result of the comparison. The attribute information of the object may include location information, color information, index information, and texture information of vertices forming the object.

For example, the attribute information included in an object in each of the first and second frames may be location information and color information. The extraction unit 810 may extract the object as the fixed object between the first and second frames when the location information and color information of the object in the first frame are the same as the location information and color information of the object in the second frame.

The extraction unit 810 may acquire rendering information of the object included in each of the first frame and the second frame. The extraction unit 810 may extract the attribute information of the object included in each of the first frame and the second frame and viewpoint information of the fixed object in each of the first frame and the second frame from the acquired rendering information. The viewpoint information of the fixed object, which is acquired by the extraction unit 810, may be the basis for acquiring information about a viewpoint difference between the first frame and the second frame by the comparison unit 820.

The comparison unit 820 may compare first viewpoint information of the fixed object in the first frame with second viewpoint information of the fixed object in the second frame. The comparison unit 820 may acquire a projection matrix including difference information between the first viewpoint and the second viewpoint.

The acquisition unit 830 may acquire geometric data of the fixed object in a second viewpoint on the basis of geometric data of the fixed object in a first viewpoint and a comparison of the viewpoint information. The acquisition unit 830 may acquire the geometric data of the fixed object in the second viewpoint by applying the projection matrix acquired by the comparison unit 820 to the geometric data of the fixed object the first viewpoint.

The acquisition unit 830 may acquire geometric data of a fixed object in a current frame on the basis of geometric data of the fixed object in a previous frame and the current frame and a comparison of the viewpoint information between the previous frame and the current frame among a plurality of frames.

The systems, processes, functions, blocks, processing steps, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a memory, a processing circuits, logic circuits, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of rendering graphics data, the method comprising:
extracting, at an extractor for rendering graphics data, an object existing at a first frame and a second frame on the basis of attribute information of the object in the first frame and attribute information the object in the second frame;
comparing first viewpoint information of the object in the first frame with second viewpoint information of the object in the second frame; and
acquiring geometric data of the object in a second viewpoint on the basis of geometric data of the object in a first viewpoint and the viewpoint comparison information.

2. The method of claim 1, further comprising acquiring geometric data of a fixed object in a current frame on the basis of geometric data of the fixed object in a previous frame and a viewpoint comparison information between the previous frame and the current frame.

3. The method of claim 1, wherein the attribute information of the object comprises any one or any combination of location information, color information, index information, and texture information of vertices forming the object.

4. The method of claim 1, wherein the extracting of the object comprises:
comparing the attribute information of the object included in the first frame with the attribute information of the object included in the second frame; and
extracting, as the object, an object having the same attribute information in the first frame and the second frame.

5. The method of claim 1, wherein the comparing comprises acquiring a projection matrix of difference between the first viewpoint and the second viewpoint.

6. The method of claim 5, wherein the acquiring of the geometric data of the object in the second viewpoint comprises applying the projection matrix to the geometric data of the object in the first viewpoint.

7. The method of claim 1, further comprising:
acquiring rendering information of the object included in the first frame and the second frame; and
extracting the attribute information and viewpoint information of the object included in the first frame and the second frame based on the acquired rendering information.

8. A non-transitory computer-readable storage medium having stored therein program instructions, which when executed by a computer, perform the method of claim 1.

9. An apparatus for rendering graphics data, the apparatus comprising:
an extractor configured to extract an object existing at a first frame and a second frame on the basis of attribute information of the object in the first frame and attribute information of the object included in the second frame;
a comparator configured to compare first viewpoint information of the object in the first frame with second viewpoint information of the object in the second frame; and
an acquirer configured to acquire geometric data of the object in a second viewpoint on the basis of geometric data of the object in a first viewpoint and the viewpoint comparison information.

10. The apparatus of claim 9, wherein the acquirer is further configured to acquire geometric data of a fixed object in a current frame on the basis of geometric data of the fixed object existing in a previous frame and a viewpoint comparison information between the previous frame and the current frame.

11. The apparatus of claim 9, wherein the attribute information of the object comprises location information, color information, index information, and texture information of vertices forming the object.

12. The apparatus of claim 9, wherein the extractor is further configured to compare the attribute information of the object included in the first frame with the attribute information of the object included in the second frame and to extract, as the object, an object having the same attribute information in the first frame and the second frame.

13. The apparatus of claim 9, wherein the comparator is further configured to acquire a projection matrix of difference between the first viewpoint and the second viewpoint.

14. The apparatus of claim 13, wherein the acquirer is further configured to apply the projection matrix to the geometric data of the object in the first viewpoint.

15. The apparatus of claim 9, wherein the extractor is further configured to acquire rendering information of the object included in the first frame and the second frame and to extract the attribute information and viewpoint information of the object included in the first frame and the second frame based on the acquired rendering information.

16. A method of rendering graphics data, the method comprising:
extracting, at an extractor for rendering graphics data, an object existing at a same location in a first frame and a second frame on the basis of attribute information of the object in the first frame and attribute information the object in the second frame;
comparing first viewpoint information of the object in the first frame with second viewpoint information of the object in the second frame;
acquiring a projection matrix of difference between the first viewpoint and the second viewpoint;
obtaining geometric data of the object in a second viewpoint based on applying the projection matrix to a geometric data of the object in the first viewpoint.

17. The method of claim 16, wherein the attribute information of the object comprises any one or any combination of location information, color information, index information, and texture information of vertices forming the object.

18. The method of claim 16, wherein the extracting of the object comprises extracting the object having the same attribute information in the first frame and the second frame.
